(19) United States
(12) Patent Application Publication
(10) Pub. No.: US 2019/0385190 A1
(43) Pub. Date: Dec. 19, 2019

(54) BONUS BASED TARGETED ADVERTISING

(71) Applicant: ADP, LLC, Roseland, NJ (US)

(72) Inventors: Kurt D. Newman, Columbus, GA (US); Debashis Ghosh, Charlotte, NC (US); Ramsay Cole, Brooklyn, NY (US)

(21) Appl. No.: 16/011,456

(22) Filed: Jun. 18, 2018

(51) Int. Cl. G06Q 30/02

(52) U.S. Cl. CPC G06Q 30/0249; G06Q 30/0269

(57) ABSTRACT

A method and apparatus for reducing an amount of resources required for targeted advertising to bonus recipients accesses a payroll database, identifies from the payroll database an employee, a bonus payment date for the employee, and a bonus payment amount for the employee, determines a selected luxury item based on a luxury item preference score in a consumer profile for the employee, determines the amount of resources assigned to a targeted advertisement for the selected luxury item, and delivers the targeted advertisement for a selected luxury item on the amount of resources, wherein using the luxury item preference score enables reducing the amount of resources for delivering the targeted advertisement eliminates advertising for luxury items with less probability of causing the employee to spend the bonus amount on a luxury item than the selected luxury item.

### BACKGROUND INFORMATION

### 1. Field

The present disclosure relates generally to a special computer system for payroll-based targeted advertising and, in particular, to a method and apparatus for reducing an amount of resources required for targeted advertising of luxury items.

### 2. Background

Companies that process payrolls for other business have access to vast amounts of data in specific geographic areas. The data may be mined for various purposes in addition to check writing, direct depositing, and creation of accounting data for company and government use. Such information may provide insights into an employee's potential buying behavior. Moreover, such information may enable inferences regarding which product an employee might purchase. However, no current systems exist to exploit the information available in payroll databases.

Companies spend vast amounts on advertising to sell products. Moreover, companies spend money to services to find suitable targets for advertising. Luxury items present significant problems to advertisers. Problems arise because the luxury items may be outside of most employees' disposable income. Moreover, the luxury items may be purchased only at certain times. One such time may be when an employee receives an additional sum of money. If such information were available, an advertiser could time their message to a particular individual. If the amount of additional money the individual were to receive could be known, an appropriate luxury item could be selected for the targeted advertisement. Currently no systems exist to provide such information to advertisers.

Therefore, it would be desirable to have a method and apparatus that take into account at least some of the issues discussed above, as well as other possible issues. For example, it would be desirable to have a method and apparatus that overcome a technical problem with reducing an amount of resources required for targeted advertising of luxury items.

### SUMMARY

An embodiment of the present disclosure provides a computer-implemented method for reducing an amount of resources required for targeting advertising of luxury items, the computer-implemented method comprising: accessing, by a special advertising application running on a processor unit, a payroll database; identifying from the payroll database, by the special advertising application running on the processor unit, an employee, a bonus payment date for the employee, and a bonus payment amount for the employee; responsive to identifying the employee, the bonus payment date, and the bonus payment amount, determining a selected luxury item based on a luxury item preference score in a consumer profile for the employee and determining the amount of resources assigned to a targeted advertisement for the selected luxury item; and delivering, by the special advertising application running on the processor unit, the targeted advertisement for a selected luxury item on the amount of resources; wherein using the luxury item preference score enables reducing the amount of resources for delivering the targeted advertisement by eliminating advertising for luxury items with less probability of causing the employee to spend the bonus amount on a luxury item than the selected luxury item.

Another embodiment of the present disclosure provides a targeted luxury item advertising delivery system for reducing an amount of resources required for targeting advertising of luxury items comprising: a computer system connected to a network, a number of internal databases, and a number of external data sources, wherein the number of internal databases include a number of payroll databases; a special advertising application running on a processor unit of the computer system; computer program instructions for the special advertising application, stored in a computer-readable storage medium and configured to cause the processor unit to access a payroll database; identify from the payroll database an employee, a bonus payment date for the employee, and a bonus payment amount for the employee; responsive to identifying the employee, the bonus payment date, and the bonus payment amount, determine the amount of resources assigned to a targeted advertisement based on a luxury item preference score in a consumer profile for the employee; and deliver the targeted advertisement for a selected luxury item on the amount of resources; wherein using the luxury item preference score enables reducing the amount of resources for delivering the targeted advertisement by eliminating advertising with a low probability of causing the employee to spend the bonus amount on a luxury item.

A further embodiment of the present invention provides a computer program product for reducing an amount of resources required for targeting advertising of luxury items comprising: computer program instructions stored on a computer-readable medium and configured to cause a processor unit to access a payroll database; computer program instructions stored on a computer-readable medium and configured to cause a processor unit to identify from the payroll database an employee, a bonus payment date for the employee, and a bonus payment amount for the employee; computer program instructions stored on a computer-readable medium and configured to cause a processor unit, responsive to identifying the employee, the bonus payment date, and the bonus payment amount, to deliver a targeted advertisement for a selected luxury item; wherein an amount of resources required for advertising is reduced.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is a diagram of an information environment in accordance with an illustrative embodiment;

FIG. 2 is a block diagram of a computer system for reducing an amount of resources required for targeting advertising of luxury items in accordance with an illustrative embodiment;

FIG. 3 is a block diagram of a consumer profile for use in reducing an amount of resources required for targeting advertising of luxury items in accordance with an illustrative embodiment;

FIG. 4 is a block diagram of an internal database in accordance with an illustrative embodiment;

FIG. 5 is block diagram of external data sources in accordance with an illustrative embodiment;

FIG. 6 is a flow chart of a process for reducing an amount of resources required for targeting advertising of luxury items in accordance with an illustrative embodiment;

FIG. 7 is a flowchart of a process for reducing an amount of resources required for targeting advertising of luxury items in accordance with an illustrative embodiment;

FIG. 8 is a flowchart of a process for reducing an amount of resources required for targeting advertising of luxury items in accordance with an illustrative embodiment;

FIG. 9 is a flowchart of a process for reducing an amount of resources required for targeting advertising of luxury items in accordance with an illustrative embodiment;

FIG. 10 is a flowchart of a process for reducing an amount of resources required for targeting advertising of luxury items in accordance with an illustrative embodiment; and

FIG. 11 is a block diagram of a data processing system in accordance with an illustrative embodiment.

### DETAILED DESCRIPTION

The illustrative embodiments recognize and take into account one or more different considerations. The illustrative embodiments recognize and take into account that sales of some luxury items, such as expensive automobiles, are influenced by bonus payments that put extra cash in the hands of potential luxury item purchasers. The illustrative embodiments recognize and take into account that advertising, such as advertising for luxury items, needs to be focused at a time when extra cash is available to a potential buyer.

As used herein, the term “luxury item” shall mean a product that is not a necessity and that has a high income elasticity of demand. Luxury items are typically more costly and are normally purchased by individuals with an above average disposable income or an above average accumulated wealth. Therefore, a luxury item is a product for which demand increases more than proportionally as income rises. In contrast, demand for a product that is a necessity increases proportionally less as income rises. Luxury items may include products at the high end of the market in terms of quality and prices and such high end of the market items, may include, without limitation, automobiles, yachts, wine, bottled water, coffee, tea, food, watches, jewelry, and high fidelity television and sound systems.

The illustrative embodiments recognize and take into account that employment data showing when various companies pay bonuses may assist marketers in targeting and reaching potential buyers. The illustrative embodiments recognize and take into account that knowing when extra cash is available to individuals is a challenge. The illustrative embodiments recognize and take into account that indices may be created to monitor when bonus payments are made across industries and geographic regions.

The illustrative embodiments recognize and take into account that indices may be created to show where individuals live that are expected to receive bonus payments. The illustrative embodiments recognize and take into account that such information may be used to help targeted advertising messages to individuals that will have extra cash through bonus payments.

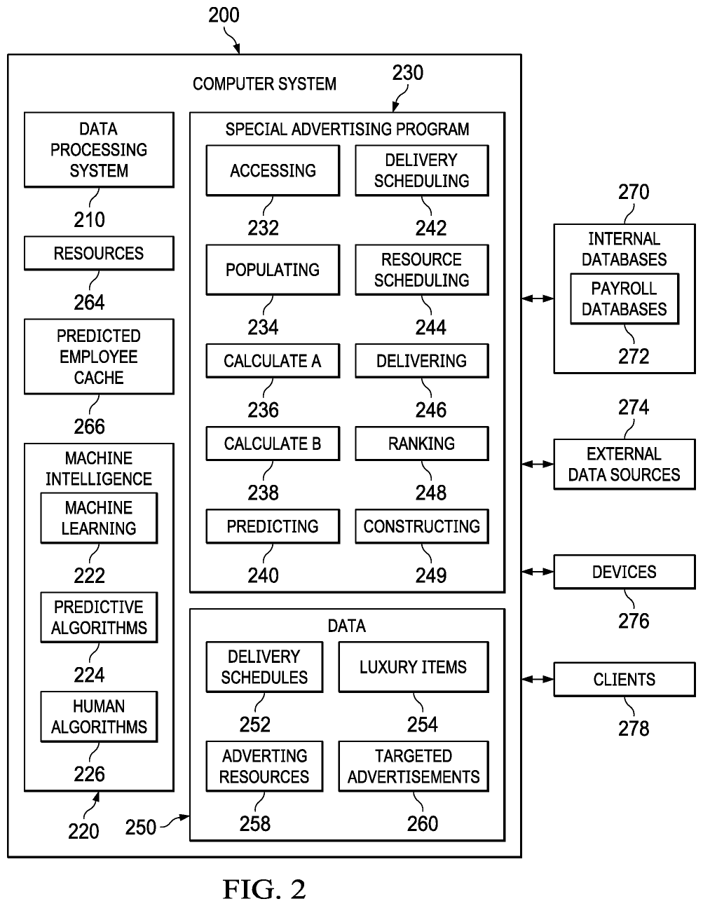

The illustrative embodiments recognize and take into account that delivering advertisements for luxury items only to individuals that will have extra cash through bonus payments will reduce the amount of resources needed to reach potential customers and to sell an amount of the luxury items. Moreover, the illustrative embodiments recognize and take into account that resources include time and money. The sooner the advertising reaches an individual who may be inclined to make a purchase, the greater the likelihood the individual will not spend available money, such as a bonus payment, on a competitor's luxury item. Moreover, processor time, memory, storage usage, and internet bandwidth have a cost so that the more processor time, the more memory and storage, and the more internet bandwidth that may be consumed, the greater the cost to deliver the advertising so that the amount realized through a sale will be lessened by the amount spent to deliver advertising. Therefore, targeted advertising as enabled by computer system 200 in FIG. 2 reduces processor time and internet bandwidth. In addition, adverting resources may comprise the software and design time spent in preparing the messages for luxury items and may consume additional processor time, memory and storage, and internet bandwidth. Therefore, targeted advertising to individuals who have or are about to receive a bonus requires less advertising resources because the amount and scope of the advertising may be limited using less resources.

As used herein, “resources” shall mean one or more of the following: (1) the amount of time to deliver an advertising message to an individual, (2) the amount of processor time and internet bandwidth used to deliver an advertising message to an individual, (3) the amount of memory and storage required for preparation and delivery of advertising messages, and (4) the amount of advertising software and design time required to prepare an advertising message for a particular luxury item.

Resources are represented below in FIG. 2 by resources 264 and advertising resources 258. In an embodiment, resources 264 may comprise an amount of time to deliver an advertising message to an individual, the amount of processor time required, the amount of memory and storage required, and the amount of internet bandwidth required to deliver an advertising message to an individual.

In an embodiment, advertising resources 258 may comprise the amount of advertising software and design time required to prepare an advertising message for a particular luxury item as well as an amount of memory and storage used in the preparation of the advertising message. In an embodiment, resources 263 may include advertising resources 258. In an embodiment, advertising resources 258 may include resources 263.

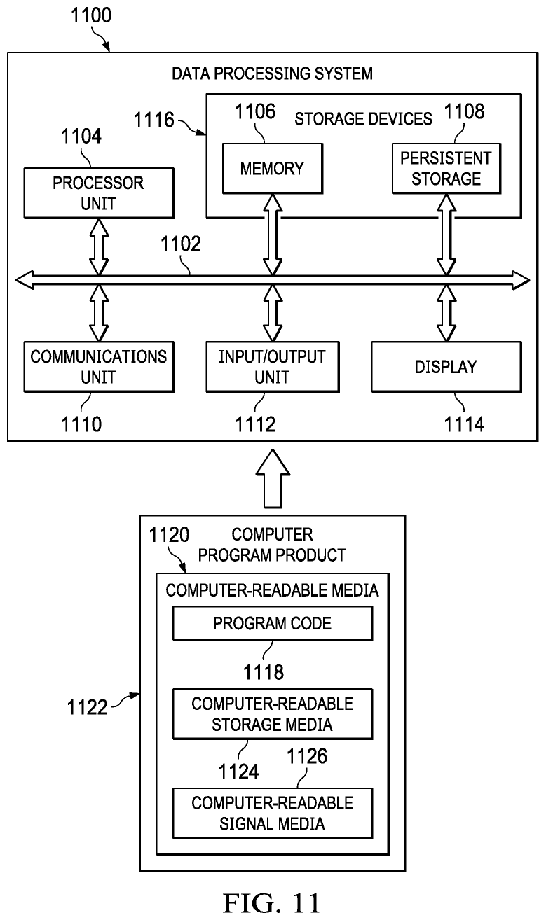

Processor time may be an amount of time processor unit 1104 in FIG. 11 spends executing instructions for analyzing, targeting, designing, storing, and delivering advertisements for luxury items, for executing instructions for one or more components of special advertising program 230 in FIG. 2, for executing instructions for one or more components of machine intelligence 220 in FIG. 2, and for executing instructions for the processes set forth in FIG. 6 through FIG. 10. Reductions in memory and storage may be reductions in memory 1106 and persistent storage 1104 in FIG. 11. Moreover, reductions in storage may be reductions in program code 1118, computer-readable storage media 1124, and computer-readable signal media 1126 in FIG. 11.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added, in addition to the illustrated blocks, in a flowchart or block diagram.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A, one of item B, and ten of item C; four of item B and seven of item C; or other suitable combinations.

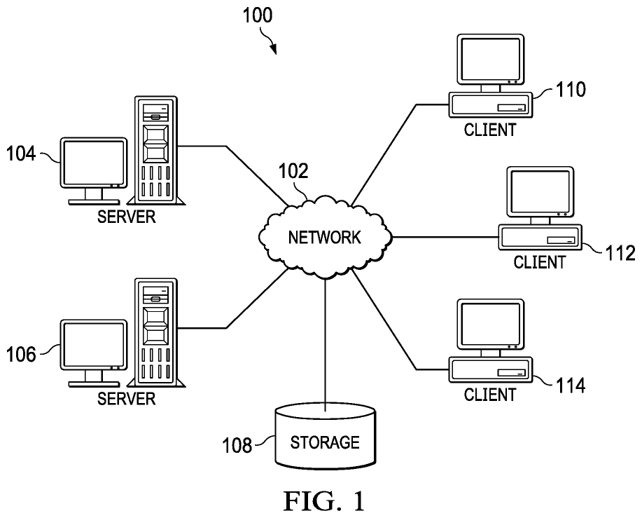

With reference now to the figures and, in particular, with reference to FIG. 1, a diagram of a data processing environment is depicted in accordance with an illustrative embodiment. It should be appreciated that FIG. 1 is only provided as an illustration of one implementation and is not intended to imply any limitation with regard to the environments in which the different embodiments may be implemented. Many modifications to the depicted environments may be made.

The computer-readable program instructions may also be loaded onto a computer, a programmable data processing apparatus, or other device to cause a series of operational steps to be performed on the computer, programmable apparatus or other device to produce a computer-implemented process, such that the instructions which execute on the computer, programmable apparatus, or other device implement the functions and/or acts specified in the flowchart and/or block diagram block or blocks.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers include client computer 110, client computer 112, and client computer 114. Client computer 110, client computer 112, and client computer 114 connect to network 102. These connections can be wireless or wired connections depending on the implementation. Client computer 110, client computer 112, and client computer 114 may be, for example, personal computers or network computers. In the depicted example, server computer 104 provides information, such as boot files, operating system images, and applications to client computer 110, client computer 112, and client computer 114. Client computer 110, client computer 112, and client computer 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

The illustration of network data processing system 100 is not meant to limit the manner in which other illustrative embodiments can be implemented. For example, other client computers may be used in addition to or in place of client computer 110, client computer 112, and client computer 114 as depicted in FIG. 1. For example, client computer 110, client computer 112, and client computer 114 may include a tablet computer, a laptop computer, a bus with a vehicle computer, and other suitable types of clients.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

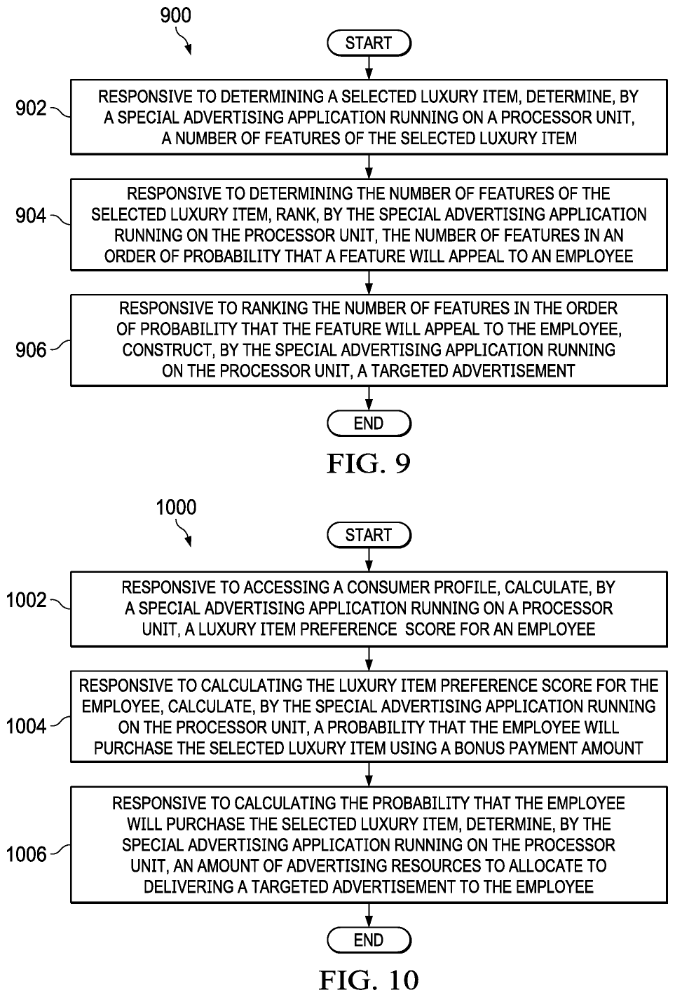

Turning to FIG. 2, a block diagram of a computer system is depicted in accordance with an illustrative embodiment. Computer system 200 may operate within a network such as network 102 in FIG. 1 and may use computers such as server computer 104, server computer 106, client computer 110, client computer 112, and client computer 114 in FIG. 1. Computer system 200 may also operate using a data processing system such as data processing system 1200 in FIG. 12. However, computer system 200 has a number of components that are configured to cause a processor unit, such as processor unit 1204 in FIG. 12, to perform tasks that a standard computer system cannot perform. Specifically, computer system 200 is made special by special advertising program 230, machine intelligence 220, and the connection of data processing system 210 to internal databases 270, to external data sources 274, to devices 276, and to clients 278 as depicted in FIG. 2. Moreover, the foregoing special components of computer system 200 operate with instructions provided by programs such as special advertising program 230 in FIG. 2 to perform algorithms as described in the flowcharts in FIGS. 9-11.

Computer system 200 comprises data processing system 210, resources 264, machine intelligence 220, special advertising program 230, and data 250. Data processing system 210 may be data processing system 1200 in FIG. 12. Machine intelligence 220 and special advertising program 230 may run on a processor unit such as processor unit 1104 in FIG. 11. Machine intelligence 220 comprises machine learning 222, predictive algorithms 224, and human algorithms 226. In this illustrative example, machine intelligence 220 can be implemented using one or more systems such as an artificial intelligence system, a neural network, a Bayesian network, an expert system, a fuzzy logic system, a genetic algorithm, or other suitable types of systems.

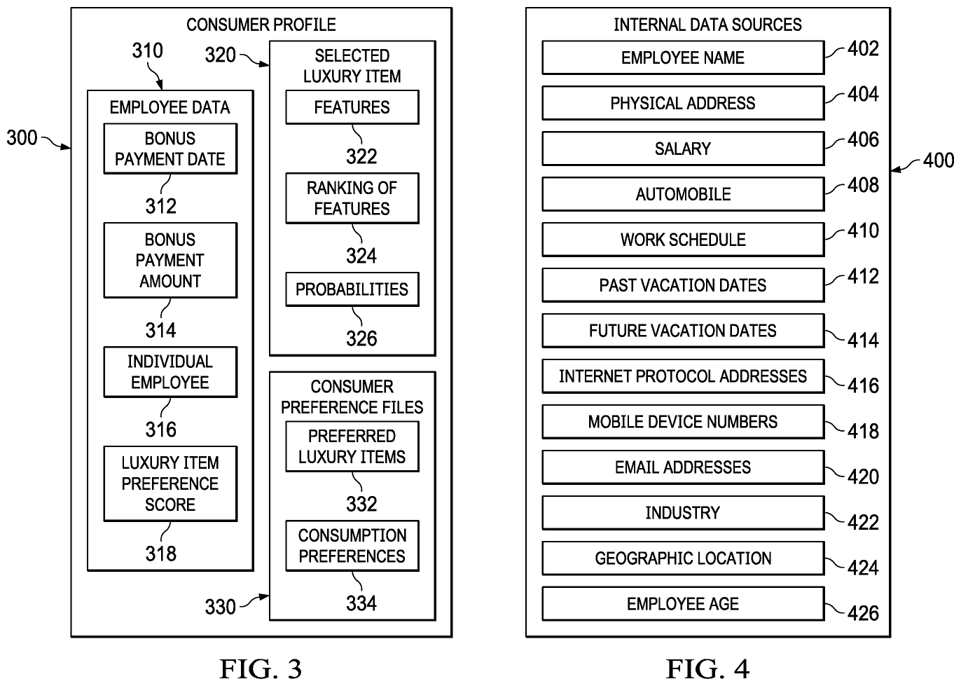

Special advertising program 230 comprises a number of applications, such as accessing 232, populating 234, calculate A 236, calculate B 238, predicting 240, delivery scheduling 242, resource scheduling 244, delivering 246, ranking 248, and constructing 249. Accessing 232 may access internal databases 270 and external databases 274 to identify indices of bonus payments and to provide data as needed by special advertising program 230. Accessing 232 may monitor internal databases 270 and external data sources 274 for indices of bonus payments by one or more organizations to one or more employees. Populating 234 may use data gathered by accessing 232 to populate consumer profile 300 in FIG. 3. Populating 234 may populate consumer profile 300 in response to calculate A 236 calculating a luxury item preference score, such as luxury item preference score 318 in FIG. 3, for an employee based on a bonus payment amount, such as bonus payment amount 314 in FIG. 3. Calculate B 238 may calculate a probability that a feature, such as a feature of features 322 in FIG. 3, of a selected luxury item, such as selected luxury item 320 in FIG. 3, may appeal to an employee who is to receive a bonus payment amount on a bonus payment date.

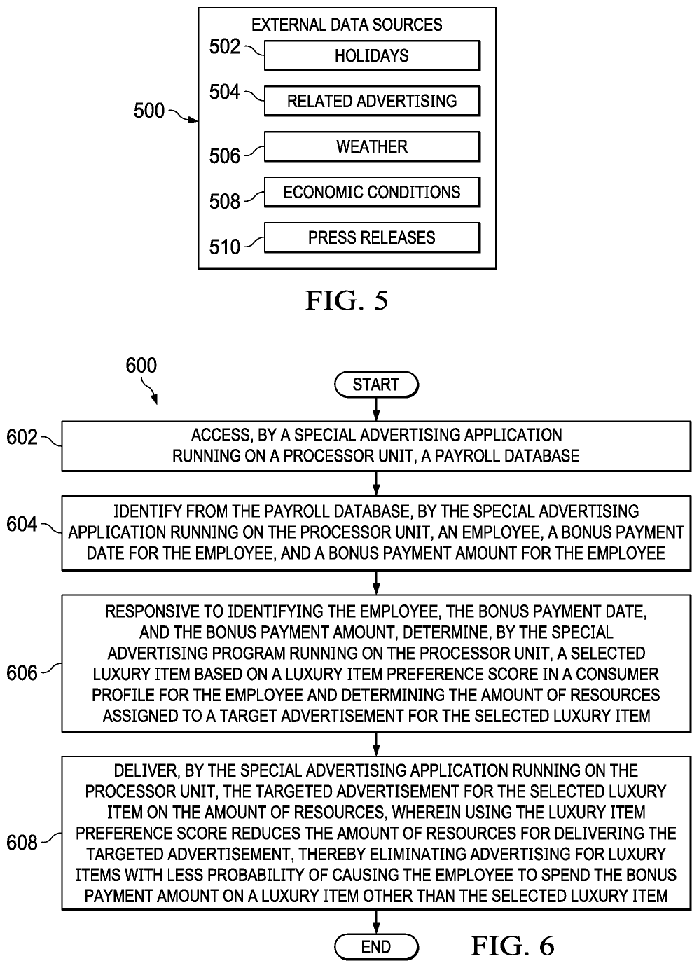

Predicting 240 may identify possible bonus payment dates based on historical data and on press announcements 510 in external data sources 500 in FIG. 5. Delivery scheduling 242 may provide delivery schedules 252 for delivery of targeted advertisements 260 to individual employee 316 in FIG. 3. Resource scheduling 244 may assign resources from resources 264 to delivering targeted advertisements 260. Delivering 246 may employ one or more resources from resources 264 in accordance with delivery schedules 252 for delivering targeted advertisements 260. Ranking 248 may rank features 322 of selected luxury item 320 in accordance with probabilities 326 in FIG. 3. Constructing 249 may construct targeted advertisements 260 in accordance with a ranking of features by ranking 248 based on features 322 and probabilities 326 in FIG. 3.

Data 250 comprises delivery schedules 252, luxury items 254, advertising resources 258, and targeted advertisements 260. Internal databases 270 may comprise payroll databases 272. Internal databases 270 may provide data such as data depicted in internal data 400 in FIG. 4. External data sources 274 may provide data such as external data sources 500 depicted in FIG. 5. Devices 276 may include a number of devices for printing, faxing, emailing, texting, and otherwise delivering targeted advertisements, such as targeted advertisements 260, to be delivered to a predicted employee from predicted employee cache 266 on resources selected from resources 264 by delivering 246 application. Clients 278 may be business organizations subscribing to a service offered by an owner of computer system 200 with access to payroll databases 272 in internal databases 270.

Computer system 200 solves a technical problem of reducing an amount of resources required for targeting advertising of luxury items. Computer system 200 accomplishes this in several ways. First, computer system 200 provides information regarding when one or more employees will receive a bonus payment. The information regarding when one or more employees will receive a bonus payment is valuable to individuals or companies that sell luxury items. As explained above, a luxury item may be a product that is not a necessity and that has a high income elasticity of demand. A luxury item is typically more costly and is normally purchased by individuals with an above average disposable income or an above average accumulated wealth. Therefore, a luxury item is a product for which demand increases more than proportionally as income rises. Thus, knowing that a person is about to receive a bonus that will increase his disposable income or accumulated wealth may mean that the person is more likely to purchase a luxury item with the bonus payment than a person who did not receive a bonus payment. Second, computer system 200 can access data regarding the individual in a consumer profile and calculate a luxury item preference score, such as luxury item preference score 318 in FIG. 3, to enable a prediction of the likelihood of the employee receiving the bonus payment to spend the bonus payment on a luxury item.

Third, computer system 200 can access data regarding the individual in a consumer profile and calculate a luxury item preference score to enable a prediction of which luxury item out of a number of luxury items the employee receiving the bonus payment would be more likely to purchase. Fourth, computer system 200 can determine a number of features of the luxury item with the highest luxury item preference score, and by using consumption preferences of the employee in the consumer profile of the employee, enable a prediction of which features would appeal most to the employee receiving the bonus payment. Computer system 200 may rank the features in order of preference to the employee who is to receive the bonus payment. Thus, the technical problem of determining who is most likely to purchase a luxury item, which luxury item the person is most likely to purchase, and which features of the luxury item have the most appeal to the employee who will receive a bonus payment, enable preparation of efficient advertising and delivery of the advertising on a schedule linked to the bonus payment date, thereby reducing advertising that would not arrive at the time of the bonus payment or that would not be directed to the luxury item and features of the luxury item that would most appeal to the employee who is to receive the bonus payment.

Thus, in one illustrative example, one or more technical solutions are present that overcome the technical problem of reducing resources assigned to advertising luxury items. Computer system 200, by identifying an employee who is to receive a bonus payment, determining a probability of the employee purchasing a luxury item, determining which luxury item would appeal most to the employee, determining which features of the luxury item would appeal most to the employee, and scheduling delivery of advertising at a time or times linked to the date the employee will receive the bonus payment, creates multiple technical effects that reduce computer resources and on-line resources in preparing, scheduling and delivery advertising for a particular luxury item to a particular individual.

As a result, computer system 200 operates as a special purpose computer system in which special advertising program 230 running on data processing system 210 and accessing payroll databases 272 enables addresses for employees to receive a bonus payment to be stored in predicted employee cache 266 for timely access of the information by clients using computer system 200 to sell luxury items in an efficient manner. In particular, special advertising program 230 transforms computer system 200 into a special purpose computer system as compared to currently available general computer systems that do not have special advertising program 230 running on data processing system 210. Furthermore, special advertising program 230 transforms computer system 200 into a delivery system on delivery schedules 252 for targeted advertisements 260 using advertising resources 258. Moreover, special advertising program 230 can use machine intelligence 220 to improve prediction using the luxury item preference score and also to improve the calculation of the luxury item preference score by employing machine learning 222, predictive algorithms 224, and human algorithms 226.

Turning to FIG. 3, a block diagram of a consumer profile is depicted in accordance with an illustrative embodiment. Consumer profile 300 comprises employee data 310, selected luxury item 320, and consumer preference files 330. Employee data 310 comprises bonus payment date 312, bonus payment amount 314, individual employee 316, and luxury item preference score 318. Selected luxury items 320 comprise features 322, ranking of features 324, and probabilities 326. Consumer preference files 330 may comprise preferred luxury items 332 and consumption preferences 334.

Turning to FIG. 4, an illustration of an internal database is depicted in accordance with an illustrative embodiment. FIG. 4 includes internal data sources 400. Internal data sources 400 may comprise employee name 402, physical address 404, salary 406, automobile 408, work schedule 410, past vacation dates 412, future vacation dates 414, internet protocol addresses 416, mobile device numbers 418, email addresses 420, industry 422 of the employee, geographic location 424 of the employee, and employee age 426.

Turning to FIG. 5, an illustration of external data sources is depicted in accordance with an illustrative embodiment. FIG. 5 includes external data sources 500. External data sources 500 may comprise holidays 502, related advertising 504, weather 506, economic conditions 508, and press releases 510.

Turning to FIG. 6, a flowchart of a process for reducing an amount of resources required for targeting advertising of luxury items is depicted in accordance with an illustrative embodiment. Process 600 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1.

Process 600 starts. A special advertising application running on a processor unit accesses a payroll database (step 602). The special advertising program may be special advertising program 230 in FIG. 2. The payroll database may be one of payroll databases 272 in FIG. 2. The special advertising application running on the processor unit identifies from the payroll database an employee, a bonus payment date for the employee, and a bonus payment amount for the employee (step 604). Process 600 ends thereafter. The employee may be individual employee 316 in FIG. 3. The bonus payment date may be bonus payment date 312 in FIG. 3. The bonus payment amount may be bonus payment amount 314 in FIG. 3. Responsive to identifying the employee, the bonus payment date, and the bonus payment amount, the special advertising application running on the processor unit determines a selected luxury item based on a luxury item preference score in a consumer profile for the employee and determines the amount of resources assigned to a targeted advertisement for the selected luxury item (step 606). The selected luxury item may be selected luxury item 320 in FIG. 3. The consumer profile may be consumer profile 300 in FIG. 3. The amount of resources may selected from resources 264 in FIG. 2. The targeted advertisement may be one of targeted advertisements 260 in FIG. 2. The special advertising application running on the processor unit delivers the targeted advertisement for the selected luxury item on the amount of resources (step 608). Delivery of the targeted advertisement may be accomplished by delivering application 246 in FIG. 2. Using the luxury item preference score reduces the amount of resources for delivering the targeted advertisement by eliminating advertising for luxury items with less probability of causing the employee to spend the bonus amount on a luxury item.

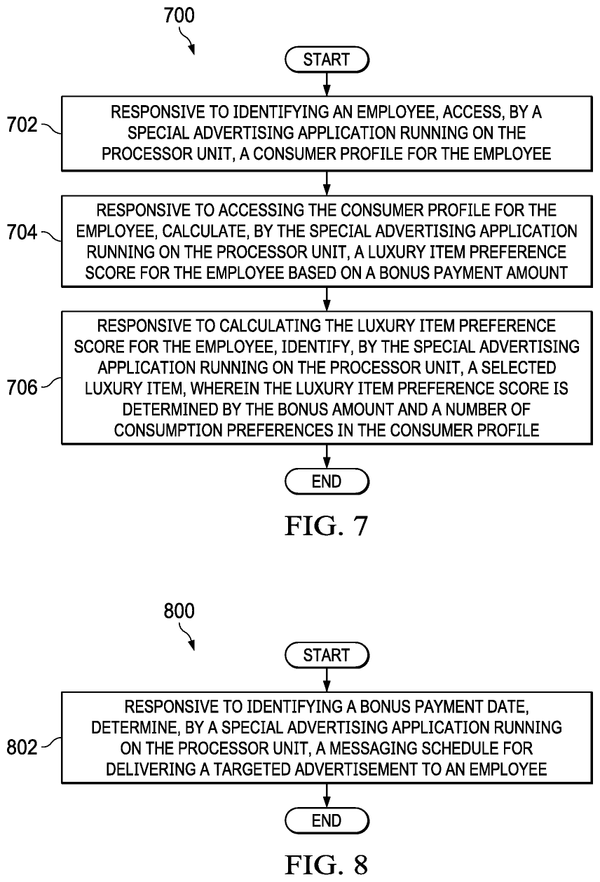

Turning to FIG. 7, a flowchart of a process for reducing an amount of resources required for targeted advertising of luxury items is depicted in accordance with an illustrative embodiment. Process 700 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1.

Process 700 starts. Responsive to identifying an employee, the special advertising application running on the processor unit accesses a consumer profile for the employee (step 702). The special advertising application may be special advertising program 230 in FIG. 2. The consumer profile may be consumer profile 300 in FIG. 3. Responsive to accessing the consumer profile for the employee, the special advertising application calculates a luxury item preference score for the employee based on the bonus payment amount (step 704). The calculation may be performed by calculate A 236 in FIG. 2. The bonus payment amount may be bonus payment amount 314 in consumer profile 300 in FIG. 3. Responsive to calculating the luxury item preference score for the employee, the special advertising application running on the processor unit, identifies a selected luxury item, wherein the luxury item preference score is determined by the bonus payment amount and a number of consumption preferences in the consumer profile (step 706). Process 700 ends thereafter. The selected luxury item may be selected luxury item 320 in FIG. 3. The consumption preferences may be consumption preferences 334 in FIG. 3.

Turning to FIG. 8, a flowchart of a process for reducing an amount of resources required for targeted advertising of luxury items is depicted in accordance with an illustrative embodiment. Process 800 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1.

Process 800 starts. Responsive to identifying a bonus payment date, a special advertising application running on a processor unit determines a messaging schedule for delivering a targeted advertisement to an employee (step 802). Process 800 ends thereafter. The bonus payment date may be bonus payment date 312 in FIG. 3. The messaging schedule may be one of delivery schedules 252 provided by delivery scheduling application 242 in FIG. 2.

Turning to FIG. 9, a flowchart of a process for reducing an amount of resources required for targeted advertising of luxury items is depicted in accordance with an illustrative embodiment. Process 900 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1.

Process 900 begins. Responsive to determining a selected luxury item, the special advertising application running on the processor unit, determines a number of features of the selected luxury item (step 902). The special advertising application may be special advertising application 230 in FIG. 2. The selected luxury item may be selected luxury item 320 in FIG. 3. The number of features of the selected luxury item may be features 322 in FIG. 3. The number of features may be populated in features 322 by populating application 234 in FIG. 2.

Responsive to determining the number of features of the selected luxury item, the special advertising application ranks the number of features in order of probability that a feature will appeal to an employee (step 904). Ranking the number of features may be performed by ranking application 248 in FIG. 2. The probabilities may be probabilities 326 in FIG. 3. The probabilities may have been calculated by calculate B 238 in FIG. 2. Responsive to ranking the number of features in the order of probability that the feature will appeal to the employee, the special advertising application running on the processor unit constructs the targeted advertisement (step 906). Process 900 ends thereafter. The targeted advertisement may be one of targeted advertisements 260 in FIG. 2. The targeted advertisement may be constructed by constructing 249 in FIG. 2.

Turning to FIG. 10, a flowchart of a process for reducing an amount of resources required for targeted advertising of luxury items is depicted in accordance with an illustrative embodiment. Process 1000 can be implemented in software, hardware, or a combination of the two. When software is used, the software comprises program code that can be loaded from a storage device and run by a processor unit in a computer system such as computer system 200 in FIG. 2. Computer system 200 may reside in a network data processing system such as network data processing system 100 in FIG. 1. For example, computer system 200 may reside on one or more of server computer 104, server computer 106, client computer 110, client computer 112, and client computer 114 connected by network 102 in FIG. 1.

Process 1000 starts. Responsive to accessing a consumer profile, calculating, by a special advertising application running on a processor unit, a luxury item preference score for an employee (step 1002). The luxury item preference score may be luxury item preference score 318 in FIG. 3. Calculating the luxury item preference score may be performed by calculate A 236 in FIG. 2. Responsive to calculating the luxury item preference score for the employee, the special advertising application running on the processor unit calculates a probability that the employee will purchase the selected luxury item using a bonus payment amount (step 1004). Calculating the probability that the employee will purchase the selected luxury item using the bonus payment amount may be performed by calculate B 238 in FIG. 2. Responsive to calculating the probability that the employee will purchase the selected luxury item, determine, by the special advertising application running on the processor unit, an amount of advertising resources to allocate to delivering a targeted advertisement to the employee (step 1006). Process 1000 ends thereafter. The amount of advertising resources to allocate may be determined by resource scheduling 244 in FIG. 2. The amount of resources may be selected from resources 264 in FIG. 2.

Turning now to FIG. 11, a block diagram of a data processing system is depicted in accordance with an illustrative embodiment. Data processing system 1100 may be used to implement network data processing system 100 in FIG. 1 as well as computer system 200 and data processing system 210 in FIG. 2. In this illustrative example, data processing system 1100 includes communications framework 1102, which provides communications between processor unit 1104, memory 1106, persistent storage 1108, communications unit 1110, input/output unit 1112, and display 1114. In this example, communications framework 1102 may take the form of a bus system.

Processor unit 1104 serves to execute instructions for software that may be loaded into memory 1106. Processor unit 1104 may be a number of processors, a multi-processor core, or some other type of processor, depending on the particular implementation.

Memory 1106 and persistent storage 1108 are examples of storage devices 1116. A storage device is any piece of hardware that is capable of storing information, such as, for example, without limitation, at least one of data, program code in a functional form, or other suitable information either on a temporary basis, a permanent basis, or both on a temporary basis and a permanent basis. Storage devices 1116 may also be referred to as computer-readable storage devices in these illustrative examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a solid state hard drive, a flash memory, a rewritable optical disk, a rewritable magnetic tape, or some combination of the above. The media used by persistent storage 1108 also may be removable. For example, a removable hard drive may be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer usable program code, or computer-readable program code that may be read and executed by a processor in processor unit 1104. The program code in the different embodiments may be embodied on different physical or computer-readable storage media, such as memory 1106 or persistent storage 1108.

Program code 1118 is located in a functional form on computer-readable media 1120 that is selectively removable and may be loaded onto or transferred to data processing system 1100 for execution by processor unit 1104. Program code 1118 and computer-readable media 1120 form computer program product 1122 in these illustrative examples. In one example, computer-readable media 1120 may be computer-readable storage media 1124 or computer-readable signal media 1126.

In these illustrative examples, computer-readable storage media 1124 is a physical or tangible storage device used to store program code 1118 rather than a medium that propagates or transmits program code 1118.

Alternatively, program code 1118 may be transferred to data processing system 1100 using computer-readable signal media 1126. Computer-readable signal media 1126 may be, for example, a propagated data signal containing program code 1118. For example, computer-readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. For example, although the illustrative examples have been described with respect to supplying human resources profile information for generating advertising, other illustrative examples may be applied to personalizing web pages generated by web servers. In this manner, the different steps illustrated may be used to provide web pages to users that are more personalized. Web pages may be modified or dynamically generated using the human resources profile information.

Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method for reducing an amount of resources required for targeted advertising of luxury items, the computer-implemented method comprising:
accessing, by a special advertising application running on a processor unit, a payroll database;
identifying from the payroll database, by the special advertising application running on the processor unit, an employee, a bonus payment date for the employee, and a bonus payment amount for the employee;
responsive to identifying the employee, the bonus payment date, and the bonus payment amount, determining a selected luxury item based on a luxury item preference score in a consumer profile for the employee and determining the amount of resources assigned to a targeted advertisement for the selected luxury item; and
delivering, by the special advertising application running on the processor unit, the targeted advertisement for the selected luxury item on the amount of resources;
wherein using the luxury item preference score enables reducing the amount of resources for delivering the targeted advertisement by eliminating advertising for the luxury items with a less probability of causing the employee to spend the bonus payment amount on a luxury item than the selected luxury item.

2. The computer-implemented method of claim 1, further comprising:
responsive to identifying the bonus payment date, determining, by the special advertising application running on the processor unit, a messaging schedule for delivering the targeted advertisement to the employee.

3. The computer-implemented method of claim 1, further comprising:
responsive to identifying the employee, accessing, by the special advertising application running on the processor unit, the consumer profile for the employee;
responsive to accessing the consumer profile for the employee, calculating, by the special advertising application running on the processor unit, the luxury item preference score for the employee based on the bonus payment amount; and
responsive to calculating the luxury item preference score for the employee, identifying, by the special advertising application running on the processor unit, the selected luxury item;
wherein the luxury item preference score is determined by the bonus payment amount and a number of consumption preferences in the consumer profile.

4. The computer-implemented method of claim 3, further comprising:
responsive to determining the selected luxury item, determining, by the special advertising application running on the processor unit, a number of features of the selected luxury item;
responsive to determining the number of features of the selected luxury item, ranking the number of features in an order of probability that a feature will appeal to the employee;
responsive to ranking the number of features in the order of probability that the feature will appeal to the employee; and
constructing, by the special advertising application running on the processor unit, the targeted advertisement.

5. The computer-implemented method of claim 1, further comprising:
responsive to accessing the consumer profile, calculating, by the special advertising application running on the processor unit, the luxury item preference score for the employee;
responsive to calculating the luxury item preference score for the employee, calculating, by the special advertising application running on the processor unit, a probability that the employee will purchase the selected luxury item using the bonus payment amount; and
responsive to calculating the probability that the employee will purchase the selected luxury item, determining, by the special advertising application running on the processor unit, an amount of advertising resources to allocate to delivering the targeted advertisement to the employee.

6. The computer-implemented method of claim 2, further comprising:
accessing one or more internal databases, by the special advertising application running on the processor unit, to populate the consumer profile for the employee;
wherein the one or more internal databases comprise one or more of an age of the employee, a physical address of the employee, a salary of the employee, an automobile of the employee, a work schedule of the employee, past vacation dates, future vacation dates, IP addresses of the employee, mobile device numbers of the employee, email addresses of the employee, an industry of the employee, and a geographic location of the employee.

7. The computer-implemented method of claim 2, further comprising accessing one or more external data sources, by the special advertising application running on the processor unit, to populate the consumer profile for the employee;
wherein the one or more external data sources comprise one or more of holidays, related advertising, weather, and economic conditions.

8. A targeted luxury item advertising delivery system for reducing an amount of resources required for targeted advertising of luxury items comprising:
a computer system connected to a network, a number of internal databases, and a number of external data sources, wherein the number of internal databases includes a number of payroll databases;
a special advertising application running on a processor unit of the computer system; and
computer program instructions for the special advertising application, stored in a computer-readable storage medium and configured to cause the processor unit to access a payroll database; identify from the payroll database an employee, a bonus payment date for the employee, and a bonus payment amount for the employee; responsive to identifying the employee, the bonus payment date, and the bonus payment amount, determine the amount of resources assigned to a targeted advertisement based on a luxury item preference score in a consumer profile for the employee; and deliver the targeted advertisement for a selected luxury item on the amount of resources;
wherein using the luxury item preference score enables reducing the amount of resources for delivering the targeted advertisement by eliminating advertising with a low probability of causing the employee to spend the bonus payment amount on a luxury item.

9. The targeted luxury item delivery system of claim 8, further comprising:
computer program instructions for the special advertising application, stored in the computer-readable storage medium and configured to cause the processor unit, responsive to identifying the bonus payment date, to determine a messaging schedule for delivering the targeted advertisement to the employee.

10. The targeted luxury item delivery system of claim 8, further comprising:
computer program instructions for the special advertising application, stored in the computer-readable storage medium and configured to cause the processor unit, responsive to identifying the employee, to access the consumer profile for the employee; responsive to accessing the consumer profile for the employee, calculate the luxury item preference score for the employee based on the bonus payment amount; and responsive to calculating the luxury item preference score for the employee, to identify the selected luxury item;
wherein the luxury item preference score is determined by the bonus payment amount and a number of consumption preferences in the consumer profile.

11. The targeted luxury item delivery system of claim 8, further comprising:
computer program instructions for the special advertising application, stored in the computer-readable storage medium and configured to cause the processor unit, responsive to determining the selected luxury item, to determine a number of features of the selected luxury item; responsive to determining the number of features of the selected luxury item, rank the number of features in an order of probability that a feature will appeal to the employee; and responsive to ranking the number of features in the order of probability that the feature will appeal to the employee, constructing the targeted advertisement.

12. The targeted luxury item delivery system of claim 8, further comprising:
computer program instructions for the special advertising application, stored in the computer-readable storage medium and configured to cause the processor unit, responsive to accessing the consumer profile, calculate the luxury item preference score for the employee; responsive to calculating the luxury item preference score for the employee, calculate a probability that the employee will purchase the selected luxury item using the bonus payment amount; and responsive to calculating the probability that the employee will purchase the selected luxury item, determine an amount of advertising resources to allocate to delivering the targeted advertisement to the employee.

13. The targeted luxury item delivery system of claim 8, further comprising:
computer program instructions for the special advertising application, stored in the computer-readable storage medium and configured to cause the processor unit, to access one or more internal databases to populate the consumer profile for the employee;
wherein the consumer profile comprises one or more of an age of the employee, a physical address of the employee, a salary of the employee, an automobile of the employee, a work schedule of the employee, past vacation dates, future vacation dates, IP addresses of the employee, mobile device numbers of the employee, email addresses of the employee, an industry of the employee, and a geographic location of the employee.

14. The targeted luxury item delivery system of claim 8, further comprising:
computer program instructions for the special advertising application, stored in the computer-readable storage medium, configured to cause the processor unit to access one or more external data sources to populate the consumer profile for the employee;
wherein the external data sources comprise one or more of holidays, related advertising, weather, and economic conditions.

15. A computer program product for reducing an amount of resources required for targeted advertising of luxury items comprising:
computer program instructions for a special advertising application stored on a computer-readable storage medium and configured to cause a processor unit to access a payroll database;
computer program instructions for the special advertising application stored on a computer-readable storage medium and configured to cause the processor unit to identify, from the payroll database, an employee, a bonus payment date for the employee, and a bonus payment amount for the employee; and
computer program instructions for the special advertising application stored on a computer-readable storage medium and configured to cause a processor unit, responsive to identifying the employee, the bonus payment date, and the bonus payment amount, to deliver a targeted advertisement for a selected luxury item;
wherein an amount of resources required for advertising is reduced.

16. The computer program product of claim 15, comprising:
computer program instructions for the special advertising application, stored on the computer-readable storage medium and configured to cause the processor unit, responsive to identifying the bonus payment date, to determine a messaging schedule for delivering the targeted advertisement to the employee.

17. The computer program product of claim 15, comprising:
computer program instructions for the special advertising application, stored on the computer-readable storage medium and configured to cause the processor unit, responsive to identifying the employee, to access a consumer profile for the employee; responsive to accessing the consumer profile for the employee, to calculate a luxury item preference score for the employee based on the bonus payment amount; and responsive to calculating the luxury item preference score for the employee, identify the selected luxury item;
wherein the luxury item preference score is determined by the bonus payment amount and a number of consumption preferences in the consumer profile.

18. The computer program product of claim 15, further comprising:
computer program instructions for the special advertising application, stored on the computer-readable storage medium and configured to cause the processor unit, responsive to determining the selected luxury item, to determine a number of features of the selected luxury item; responsive to determining the number of features of the selected luxury item, rank the number of features in an order of probability that a feature will appeal to the employee; responsive to ranking the number of features in the order of probability that the feature will appeal to the employee, to construct the targeted advertisement.

19. The computer program product of claim 15, further comprising:
computer program instructions for the special advertising application, stored in the computer-readable storage medium and configured to cause the processor unit, responsive to accessing the consumer profile, to calculate a luxury item preference score for the employee; responsive to calculating the luxury item preference score for the employee, calculate a probability that the employee will purchase the selected luxury item using the bonus payment amount; and responsive to calculating the probability that the employee will purchase the selected luxury item, determine an amount of advertising resources to allocate to delivering the targeted advertisement to the employee.

20. The computer program product of claim 15, further comprising:
computer program instructions for the special advertising application, stored on the computer-readable storage medium and configured to cause the processor unit, access one or more internal databases to populate the consumer profile for the employee; and
computer program instructions for the special advertising application, stored in the computer-readable storage medium and configured to cause the processor unit to access one or more external data sources to populate the consumer profile for the employee;
wherein the consumer profile comprises one or more of an age of the employee, a physical address of the employee, a salary of the employee, an automobile of the employee, a work schedule of the employee, past vacation dates, future vacation dates, IP addresses of the employee, mobile device numbers of the employee, email addresses of the employee, an industry of the employee, and a geographic location of the employee;
wherein the external data sources comprise one or more of holidays, related advertising, weather, and economic conditions.
